(19) United States
(12) Patent Application Publication
(10) Pub. No.: US 2008/0028328 A1
(43) Pub. Date: Jan. 31, 2008

(54) System and method to dynamically change object data patterns

(75) Inventors: Arjun Prasad Hoizal, Bangalore (IN); Himabindu B., Tirupathi (IN); Karthikeyan A., Chennai (IN); Prabhat Raman, Bangalore (IN); Vasudha S., Salem (IN)

Correspondence Address: SAP/BLAKELY, 1279 OAKMEAD PARKWAY, SUNNYVALE, CA, 94085-4040, US

(73) Assignee: SAP AG

(21) Appl. No.: 11/496,745

(22) Filed: Jul. 31, 2006

(51) Int. Cl. G06F 9/00

(52) U.S. Cl. 715/763; 715/764; 715/810; 717/109; 715/967

(57) ABSTRACT

A system and method for displaying UI pattern elements. An Object Data Pattern (ODP) which is a type of UI pattern element provides for display of data in a row or a portion of the view. The ODP displays data in one portion of the view, while another ODP to which the ODP is connected displays data in another portion of the view. One of the second ODP may have number of icons, each icon associated with and connected to at least another ODP in the first portion of the view. Based on the user selection in the second ODP, the associated data from the connected ODP is displayed.

### TECHNICAL FIELD

Embodiments of the invention generally relate to the field of User Interfaces (UI) for data processing systems and, more particularly, to a system and method for using UI building blocks to model UIs. More particularly the invention relates to allowing different pattern elements to be displayed in a single view by dynamically changing object data patterns (ODPs).

### BACKGROUND

The recent trend in UI development is to raise the level of abstraction between the UI and the data processing system. Increasing the level of abstraction helps reduce the amount of code that programmers need to write to create the UI, and hence allows UIs to be created more quickly. Abstraction uses UI building blocks for modularity, standardized connectivity, loose coupling and incremental design to software applications.

In software development, the requirements of a business application are represented as models during the specification phase. UI prototypes are created in the specification phase and are modeled in a graphical-oriented application. This graphical-oriented application aids to build new applications and to deploy them. An example of a graphical-oriented application is Netweaver Visual Composer, available from SAP AG, the assignee of this patent application. During the next phase of software development, the design phase, details of these business requirements are modeled using objects, interfaces, and models, as defined in the specification phase.

A typical UI design consists of several generic building blocks for building UIs. Typical examples of generic building blocks are a floorplan and pattern elements. The floorplan determines the layout on a screen and interaction of pattern elements on the screen. A typical floorplan has several pattern elements embedded in it, each of these pattern elements providing a specific UI functionality. Depending on the selection of a specific floorplan, only certain UI pattern elements are allowed. In software engineering and designs, a pattern is a design solution that solves a generic, recurring problem efficiently and effectively. Likewise, each pattern element covers a specific task common to a large number of applications. For example, to build a UI screen for an activity of a business process, the activity is mapped on to the UI floorplan having pattern elements such as titles, toolbars, and input areas, and UI controls such as, buttons, scrollbars etc.

Each pattern element may have number of icons. Each of these icons may be associated with and connected to at least one another pattern element, either of the same or a different pattern than the pattern element to which it belongs. The icons are a representation of connections to other pattern elements, and the selection of an icon in one pattern element causes the display of a connected pattern element.

In the prior art, when developing a view of a UI, where one or more pattern elements are to be displayed, only identical pattern elements can be displayed in the same view due to a limitation of the building blocks or limitation of the modeling and configuring tools used to build the UI. Thus, the UI application developer cannot display different pattern elements in the same view.

### SUMMARY OF THE INVENTION

In one embodiment of the invention, an Object Data Pattern (ODP) provides for display of data in a first portion of a view, and this ODP connects to multiple ODPs in a second portion of the view. The ODP in the first portion of the view has multiple icons representing multiple connections each to different ODPs in the second portion, and selection of an icon causes a different ODP in the second portion to be displayed.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 illustrates a UI screen layout including building blocks, according to an embodiment of the invention.

FIG. 2 is a screenshot of a graphical oriented application development tool used to configure UI building blocks, according to an embodiment of the invention.

FIG. 3 is a flowchart illustrating an overview of the UI configuration process using the UI building blocks, according to an embodiment of the invention.

FIG. 4 is a screenshot of a graphical oriented application development tool depicting creation of a model, according to an embodiment of the invention.

FIG. 5 is a screenshot of a graphical oriented application development tool depicting selection a floorplan, according to an embodiment of the invention.

FIG. 6 is a screenshot of a graphical oriented application development tool depicting binding a business object to the floorplan, according to an embodiment of the invention.

FIG. 7 is a screenshot of a graphical oriented application development tool depicting adding pattern elements to a view object, according to an embodiment of the invention.

FIG. 8 is a screenshot of a graphical oriented application development tool depicting adding and configuring Object Selection Pattern (OSP) to the view, according to an embodiment of the invention.

FIG. 9 is a screenshot of a graphical oriented application development tool depicting adding and configuring Simple Object Data Pattern (SODP) to the view, according to an embodiment of the invention.

FIG. 10 is a screenshot of a graphical oriented application development tool depicting adding and configuring of a SODP to the view, according to an embodiment of the invention.

FIG. 11 is a screenshot of a graphical oriented application development tool depicting the execution of the UI building blocks and generation of the model, according to an embodiment of the invention.

FIG. 12 is a flow diagram illustrating aspects of a method to dynamically change object data pattern (ODPs), according to an embodiment of the invention.

FIG. 13 is a flow diagram illustrating aspects of a method to dynamically change nested object data pattern (ODPs), according to an embodiment of the invention.

FIG. 14 illustrates a graphical oriented application development tool's view for modeling ODPs, according to an embodiment of the invention.

FIG. 15 through FIG. 18 depicts modeling the SODP's in a graphical oriented application development tool, according to an embodiment of the invention.

FIG. 19 provides an illustration of a screen in which a first tab is selected, according to an embodiment of the invention.

FIG. 20 provides an illustration of a screen in which a second tab is selected, according to an embodiment of the invention.

### DETAILED DESCRIPTION

Embodiments of the invention are generally directed to a system and method for using User Interface (UI) building blocks. An object data pattern (ODP) is an example of a pattern element, a pattern element is one type of a UI building block. An ODP is a standard solution to a specific task and may be used to provide for display of data in a row or a portion of the UI. The portion of a view can be a row, window, frame, pop up screen, message box or panes or side-by-side in columns. In an embodiment, an ODP that displays data in one portion of the UI view connects to multiple ODPs in a second portion of the view. The ODP in the first portion of the view has multiple icons representing multiple connections, each connection to a different ODP in the second portion. An example of an icon is a button or a tab. Selection of an icon in the ODP the first portion of the view causes the ODP in the second portion for which it represents a connection to be displayed. Based on the user selection of an icon in the ODP in the first portion of the view, the associated data from the connected ODP in the second portion of the view is displayed.

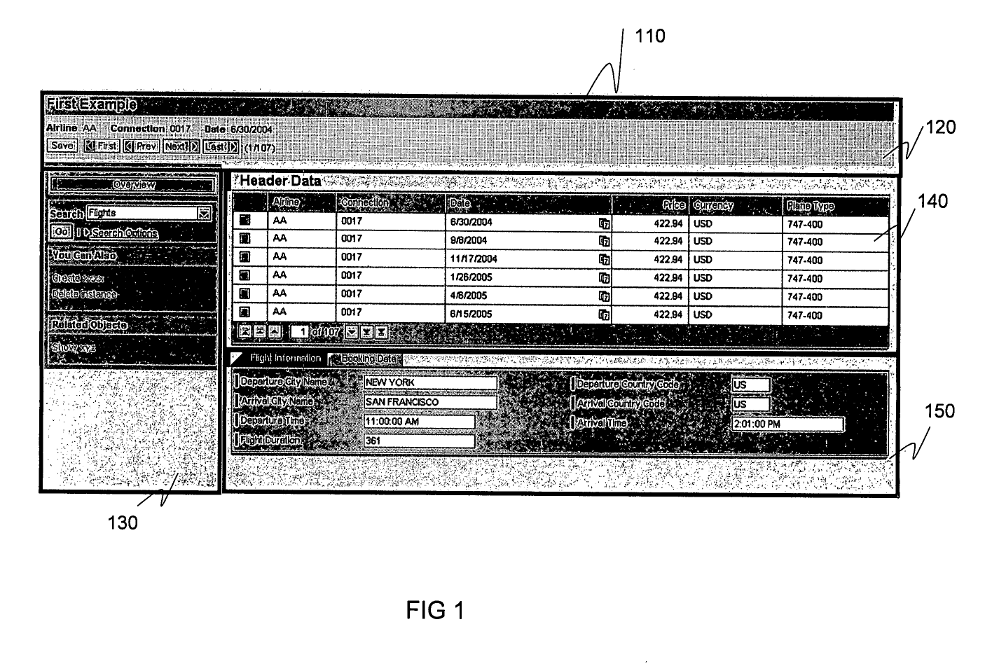

FIG. 1 is a screenshot depicting the UI screen layout including building blocks and pattern elements. One example of a building block is floorplan 110. Floorplan 110 is a screen layout having several pattern elements such as identification pattern 120, contextual navigation pattern 130, object selection pattern 140, and simple object data pattern 150. The identification pattern 120 provides the user with information about the selected object, the status of the object, or navigational information. The contextual navigation pattern 130 provides object searching capabilities by providing access to views, search and related functions. This pattern 130, can either be expanded to show the available tasks or collapsed to hide these tasks, as per the user needs. The object selection pattern 140 provides for selection of an object or a task by a user. Each row in pattern 140 represents a single object and the columns show the key fields of this object. The simple object data pattern (ODP) 150 provides a means for editing and deleting data for an object and maintaining details of the selected object. In another embodiment, an ODP may be nested within other ODPs.

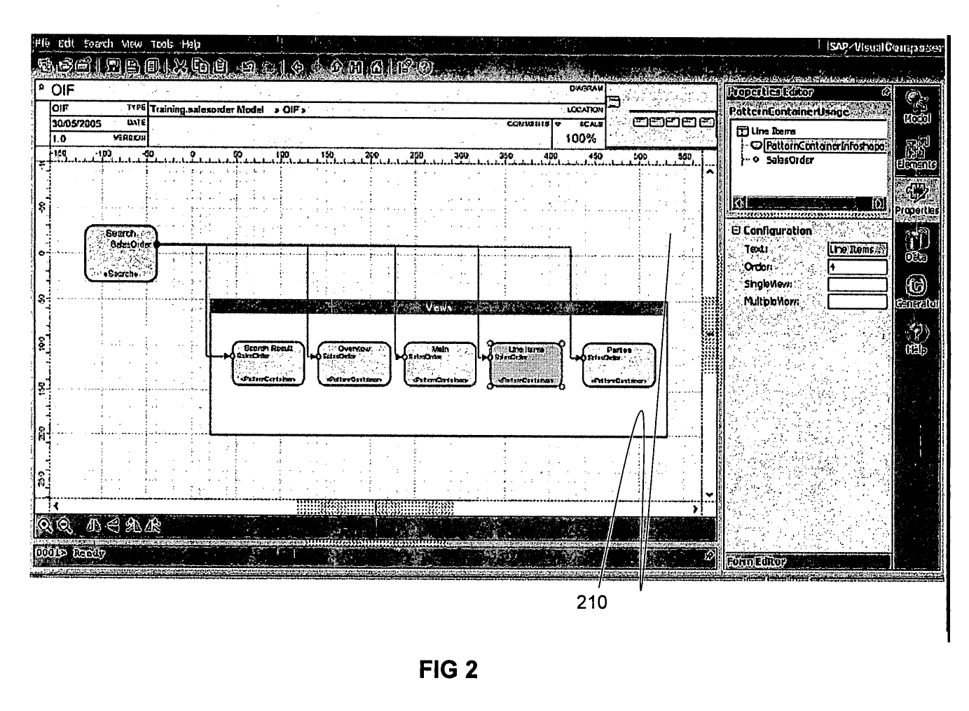

FIG. 2 illustrates a graphical oriented application development tool (Visual Composer) used to model and configure the above defined UI building blocks, according to an embodiment of the invention. This graphical oriented application development tool assists in code-free creation of application UIs. This tool helps to create a model, select a floorplan, bind business objects to the floor plan, adding views and then finally also to execute the model. As depicted in FIG. 2, the Visual Composer is used to model and configure UI building blocks of FIG. 1, such as floorplan 110 and business objects such as identification pattern 120, contextual navigation pattern 130, object selection pattern 140 and simple object data pattern 150. For example, FIG. 2 illustrates the Visual Composer used to model the contextual search pattern 130 defined for a floorplan 110.

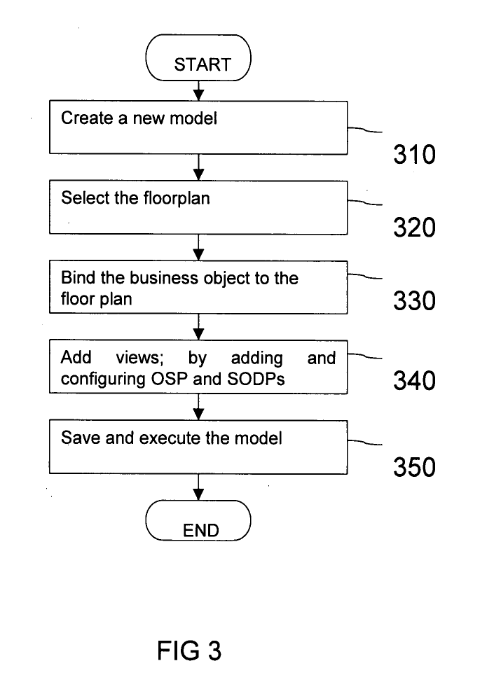

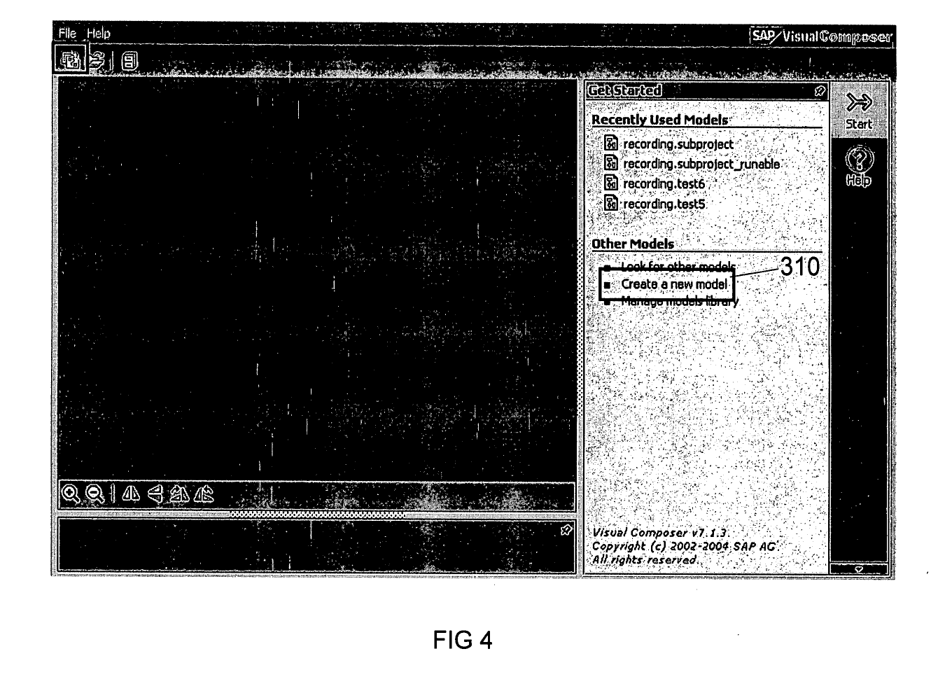

Acco rding to an embodiment of the invention, FIG. 3 is a flowchart illustrating an overview of the UI building block configuration process using the Visual Composer as depicted in FIG. 2. The detailed working of the Visual Composer for the entire process of modeling and configuring the objects is explained in the following FIG. 4 through FIG. 7. The configuration process beings with a model creation 310. Next an appropriate floorplan is selected 320. A floorplan is used for any activities that include viewing, creating or editing business objects, approving or rejecting informational requests, viewing search results for business objects, and reviewing historical data in reports. Depending upon the needs, a number of floorplan can be activated. After the floorplan selection 320, the business objects are bound 330 to the selected floor plan. A business object is an object that performs a specific business function. Examples of business objects are Invoice and Purchase Order. The UI developer creates a new business object either from scratch, templates, or references. The UI developer updates or deletes data from a business object and also verifies whether data are correct and up-to-date in this object. Creation and editing of business objects is performed in the selected floorplan. Binding a business object means mapping the corresponding real work activity to the business object. Next several other UI pattern elements are added and configured 340 on this floor plan. Examples of these pattern elements are identification pattern 120, contextual navigation pattern 130, object selection pattern 140 and simple object data pattern (SODP) 150 as depicted in FIG. 1. All this modeling and configuration is done using a graphical oriented application such as Visual Composer 210 of FIG. 2. Further the Visual Composer is used to save and execute the model at 350.

FIG. 4 illustrates process block 310 of FIG. 3 according to an embodiment of the invention, in which the Visual Composer creates and names a model of a UI to be displayed. Once the user clicks on the button to create a new model 310, the system opens a new model and names it. The user can rename the model and then save the model.

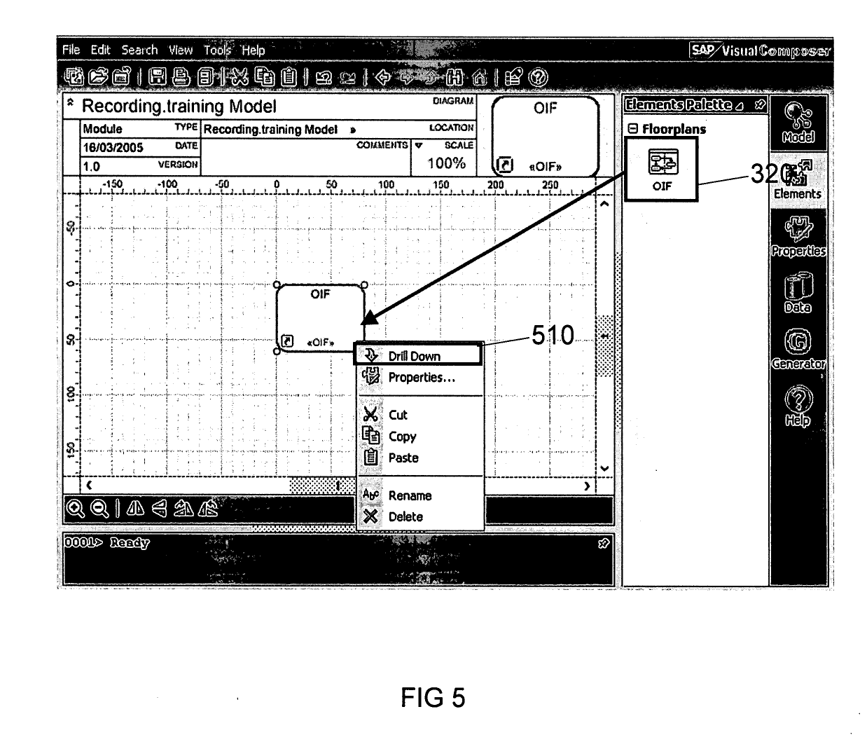

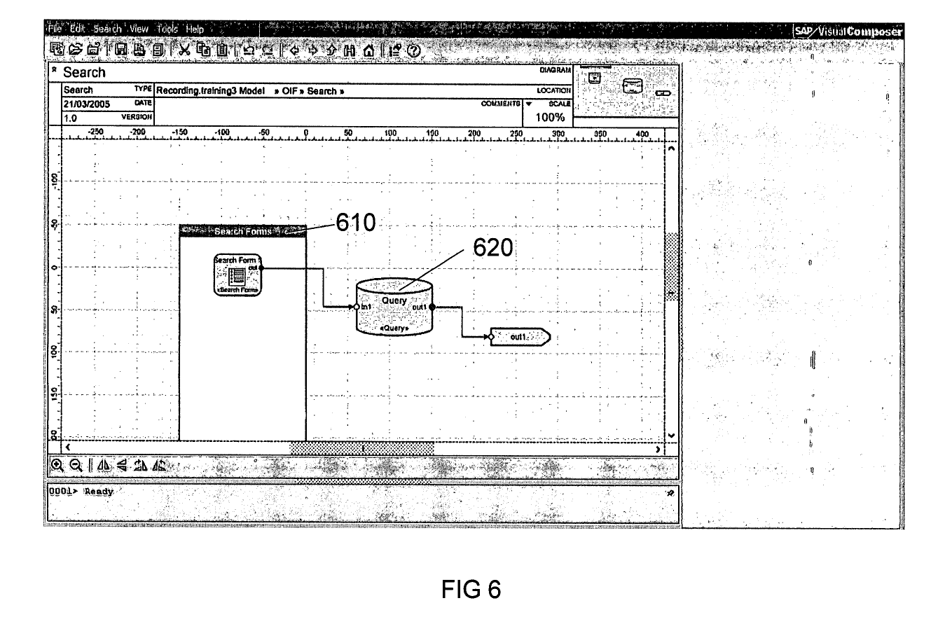

FIG. 5 illustrates process block 320 of FIG. 3 according to an embodiment of the invention, in which one selects a floorplan in the Visual Composer, for example, based on business needs. In one embodiment of the invention, the selected floorplan has objects such as Search and View as shown in FIG. 6. The search object provides for searching or querying via the UI. The view object aids to display data via the UI. One navigates at 510 this floorplan to configure these objects.

FIG. 6 illustrates process block 330 of FIG. 3 according to an embodiment of the invention, in which Visual Composer binds a Business Object such as a Search Forms 610 to the floorplan. The business object provides for specific business functionality. This object is then bound on the UI to the floorplan as per the UI needs. A query for a selected business object can also be dragged and dropped 620 on the floorplan.

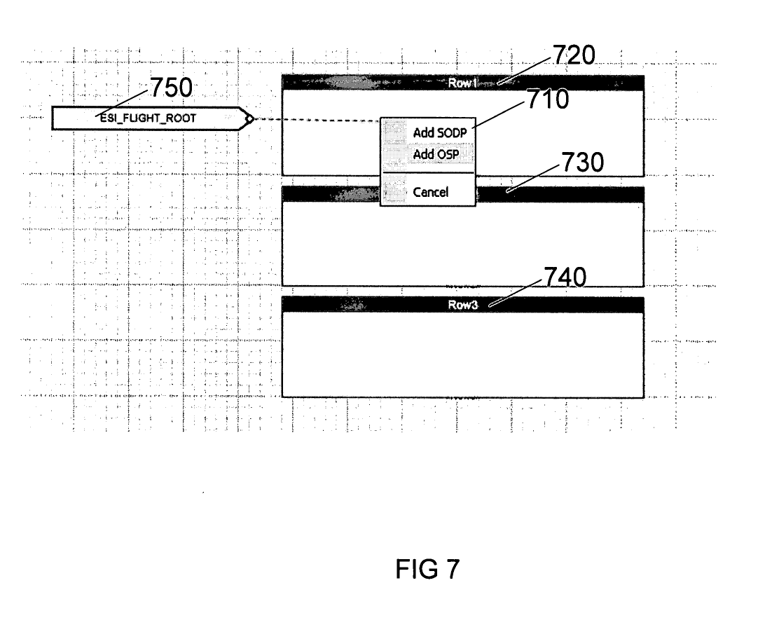

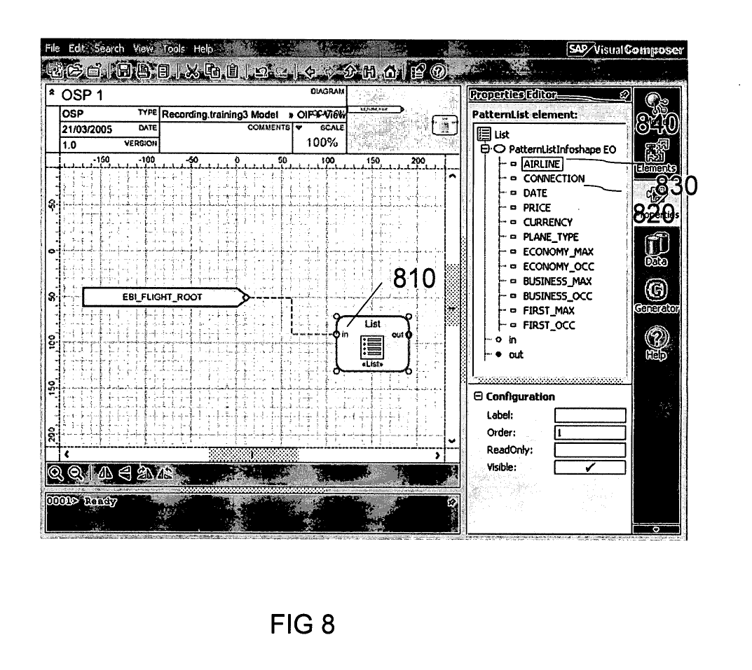

Similarly as illustrated in FIG. 7, one can configure another pattern element such as OSP or SODP 710 added to a view object using a Visual Composer, according to an embodiment of the invention. The view object aids to display data via the UI. The view comprises one or more rows 720, 730 and 740 as depicted in the FIG. 7. A row may be a window, pane, frame or a portion of the UI. A data source may be dragged into a row to link the row with data 750. Then, depending on a business requirement, a suitable pattern element such as OSP or SODP is added at 710 and one navigates to the element in order to observe the details. Examples of these UI pattern elements added and configured on this floorplan are List and Form. A List is used to edit and displays textual data in a list and may be scrollable. A form is used to edit and display the textual data for a single record of information. A typical form is displayed with labels preceding data values with key groupings of information organized together, yet separated spatially from one another. A simple object data pattern (SODP) is a UI pattern element for data display used in the floorplan to show Forms, Tables, and Master-Detail relationships. This SODP features tab strips that allow related data to be grouped together and layered. It also provides a toolbar so that actions can be taken on the data displayed within the SODP. Further FIGS. 8, 9 and 10 are specific examples for adding and configuring pattern elements.

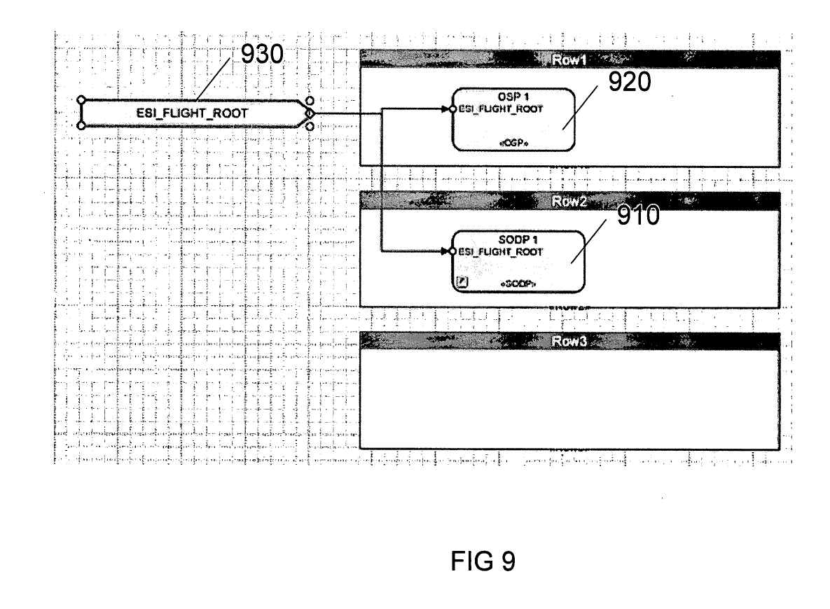

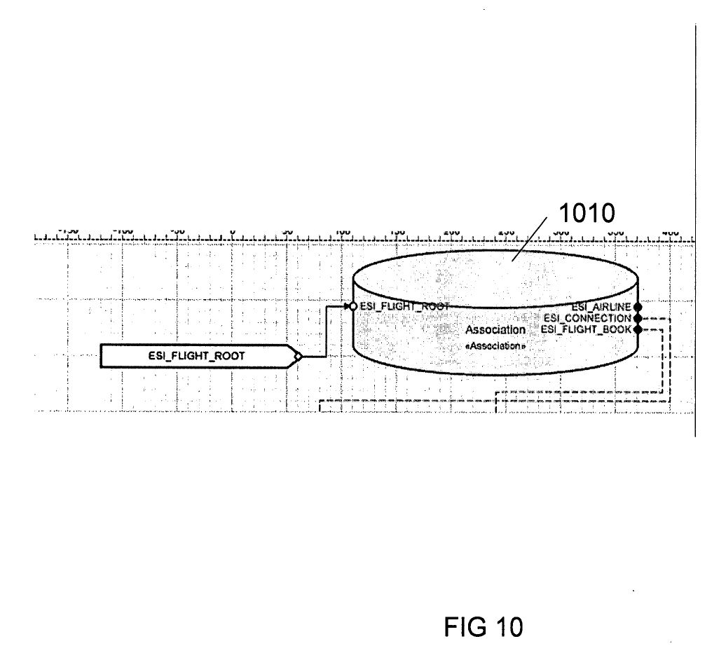

FIG. 8 illustrates process block 340 of FIG. 3 in which the Visual Composer is used to configure the view 710 of FIG. 7, by adding an OSP 810, according to an embodiment of the invention. The OSP 810 is a list that is configured by selecting one field 820 after the other 830 in the properties editor 840 of the Visual Composer. The user selected field is to be displayed. According to another embodiment of the invention, FIG. 9 illustrates the Visual Composer for configuring the view object 710 of FIG. 7, by adding an SODP 910. The SODP 910 and OSP 920 are connected to the data source 930. The SODPs are populated using data from the data source. An SODP may be a form that is added and allows one to choose the fields and the number of columns that are to be displayed in a list as in the SODP that is to be added. According to another embodiment of the invention, FIG. 10 illustrates the Visual Composer for configuring the view 710 of FIG. 7, using an SODP. The SODP is populated with data obtained from associations 1010 defined in the data model.

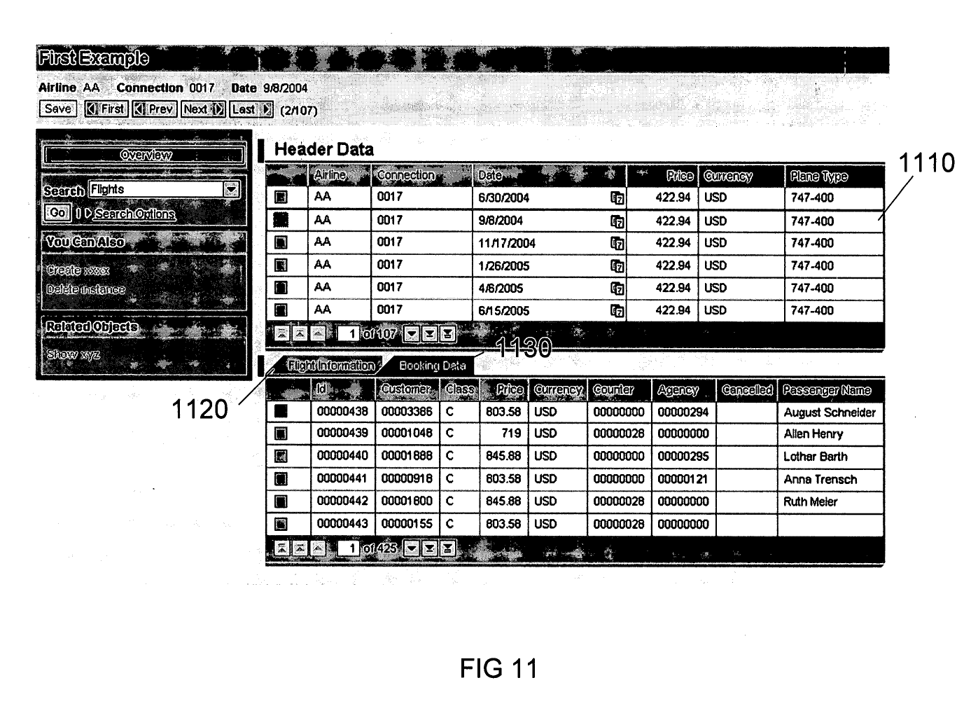

FIG. 11 illustrates process block 350 of FIG. 3, saving and executing the UI model. Post execution the UI screen renders the pattern elements as illustrated in FIG. 11. The screenshot depicts a field such as airline 1110 selected in a portion of the view and its corresponding data displayed in the second portion of the view. The corresponding data depicts, for the field selected airline 1110, its flight information 1120 and booking data 1130. This data in the second portion of the view changes dynamically as per corresponding selection in the first portion of the view.

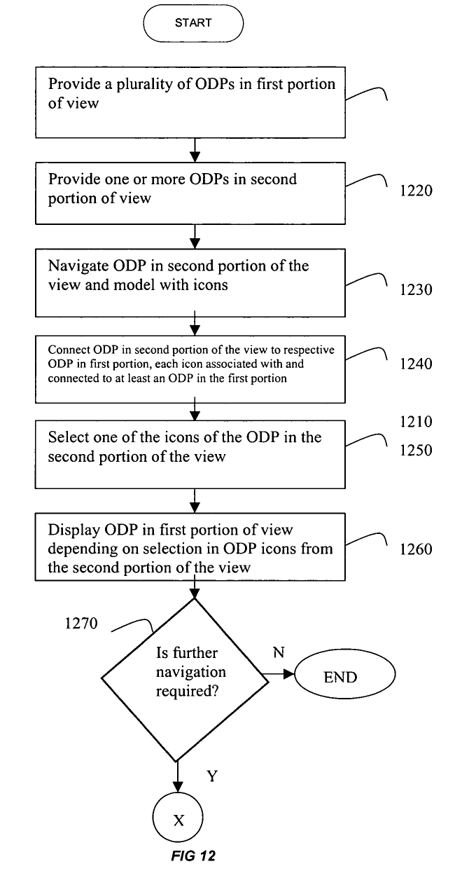

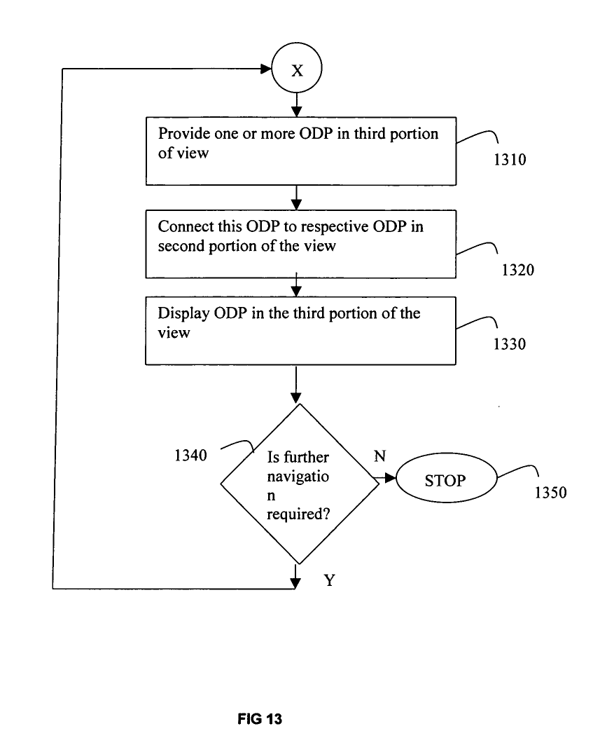

According to an embodiment of the invention, FIG. 12 is a flow diagram illustrating process block 340 of FIG. 3 which involves adding and configuring a SODP in a certain aspects of a method to dynamically change object data pattern (ODPs). Referring to process block 1210, the system provides a plurality of ODPs in first portion of the view. The view may have rows, where a row is just a portion of the UI screen. In another embodiment, the ODP is a list(s) or form(s). According to another embodiment, the system provides one or more ODPs in the second portion of the view 1220. One navigates the ODPs in the second portion of the view and models it at 1230 with a number of icons as per the design requirements. This ODP in the second portion of the view is connected to a respective ODP from the first portion of the view 1240, each icon associated with and connected to at least an ODP in the second portion of the view. On a user selecting one of the icons 1250 of the second portion of the view, the ODP in the first portion of the view changes respectively. The displayed ODP in the first portion of the view is in response to the selection of icon in the ODP in the second portion of the view 1260. In another embodiment the system checks whether further navigation of the ODP in the first portion of the view is required 1270, and if so then proceeds to step X 1310 as illustrated at the beginning of FIG. 13. If no further navigation is required then at 1270 the process stops.

According to another embodiment of the invention, as depicted in FIG. 13, the process continues at 1270 where further navigation is required. FIG. 13 illustrates the detailed flow of process block 340 of FIG. 3 for configuring views, by adding an ODP as initiated in FIG. 12.

FIG. 13 is a continuing flow diagram illustrating certain aspects of a method to dynamically change nested object data pattern (ODPs), according to an embodiment of the invention. In an embodiment of the invention, after the addition and configuration of ODPs in the first and second portion of the view and connecting them as explained above with reference to FIG. 13, the system checks whether further navigation is required 1270, and if yes then proceeds to step 1310 to provide ODPs in the third portion of the view. Further these provided ODPs in the third portion of the view are connected to respective ODPs in the first portion of the view 1320. Each of these ODPs has a separate connection and an association with one of the icons of the ODPs in first portion of the view. These connected ODPs display information in the third portion of the view depending on the user selection of icons associated to ODPs in the first portion of the view 1330. The system checks whether further navigation is required 1340, and if so then proceeds to step 1310 onwards until no further navigation is required. If further no navigation is required 1350 then the process stops.

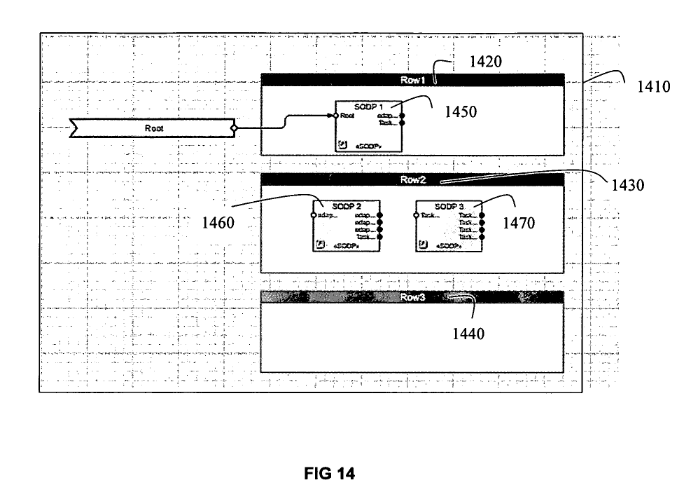

In one embodiment of the invention, FIG. 14 shows the Visual Composer view for modeling ODPs. As depicted in FIG. 13, process block 1310 to process block 1360 provides for modeling and configuring ODPs in a portion of the view. In an embodiment of the invention, a SODP is a type of ODP. As depicted in the view 1410, the view has three rows, i.e., Row1 1420, Row2 1430 and Row3 1440, wherein each row is a portion of the UI screen. The view 1410 contains data in two rows 1420, 1430 also as explained in process block 1210 and 1220 of FIG. 12 for providing ODPs in the respective portion of the view. Data in these two rows are displayed in SODPs 1450, 1460 and 1470. The SODP in the first row 1450 contains two tabs which contain different data. The tab can also be an icon. Depending on the selection of the tab in this SODP 1450 the respective SODP in the second row is displayed i.e. either 1460 or 1470, as explained in process block 1230 to process block 1260 of FIG. 12 on selection of one of the icons.

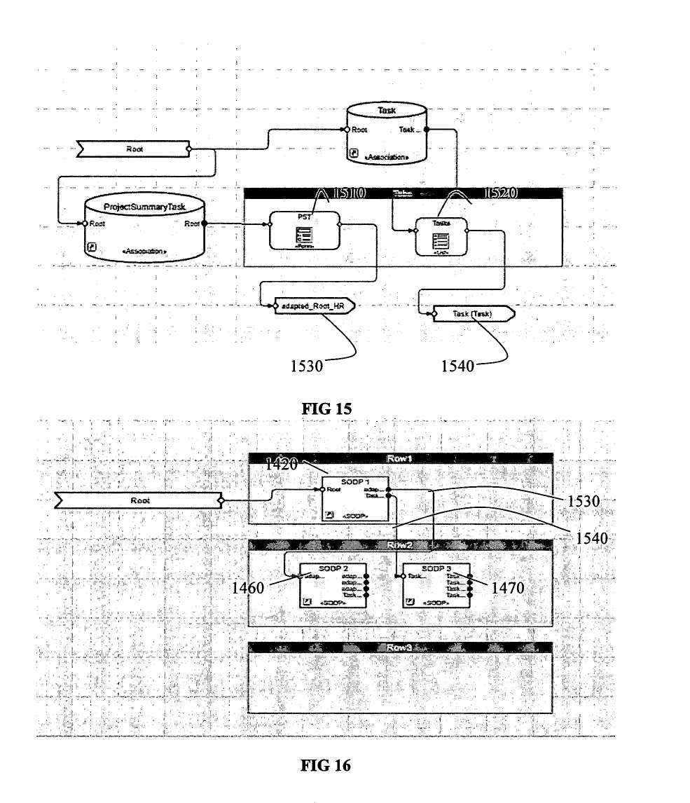

The Visual Composer as depicted in the FIGS. 15 through 18 demonstrate example of how the above stated solution can be achieved.

In an embodiment of the invention, as depicted in FIG. 15, first a SODP (i.e. SODP 1 1550) is modeled in Row 1 1520 of the view, as per process block 1210 of FIG. 12. In an embodiment of the invention, depending on the number of tabs in this SODP 1 1450, the exact number of SODPs in Row 2 1430 of the view are configured, as per process block 1220 and 1230 of FIG. 12. As depicted in the example, SODP 1 has two tabs, namely SODP 2 1460 and SODP 3 1470, in Row 2 of the view, as per process block 1220 of FIG. 12.

In an embodiment of the invention, FIG. 16 depicts SODP 1 1450 of FIG. 14 having been navigated and modeled with a number of tabs or icons, as per process block 1230 of FIG. 12. In an embodiment of the invention, as depicted in FIG. 16 the tabs titled Project Scheduling Task (PST) 1510 and Tasks 1520 are created. Further separate outports (adapted_Root_HR 1530, Task 1540) for each of these two tabs 1510 and 1520 are created.

In an embodiment of the invention, FIG. 16 depicts these outports of SODP 1 (1530 and 1540 of FIG. 15) connected to the respective SODP in Row 2 i.e. respectively to SODP 2 1460 or SODP 3 1470, as per process block 1240 of FIG. 12. The adapted_Root_HR outport 1530 is connected to SODP 2 1460 and Task outport 1540 is connected to SODP 3 1470, as depicted in process block 1240 of FIG. 12. By this connection, depending on the selection of a tab in SODP 1 1420 the required SODP in Row 2 is displayed in this case either 1460 or 1470, as per process block 1250 of FIG. 12. If PST tab 1510 in SODP 1 1450 is selected then SODP 2 1460 is displayed. Furthermore, if Tasks tab 1520 is selected then SODP 3 1470 is displayed, i.e. selection of a tab of one SODP changes the second SODP as per process block 1360 of FIG. 13. FIGS. 17 and 18 depict each of these individual connections to the respective SODPs.

In an embodiment of the invention, FIG. 17 depicts SODP 2 1460 as having been navigated and modeled as per the requirement, as process block 1210 of FIG. 12. In an embodiment, one can add a number of tabs. Examples of tabs as depicted in the FIG. 17 are Basic data 1710, Service 1720, Scheduling 1730 and attachments 1740. Each of these tabs has a corresponding association to an ODP in another portion of the view, as per process block 1320 of FIG. 13.

In an embodiment of the invention, FIG. 18 depicts SODP 3 1470 which is navigated and modeled as per the requirement, process block 1320 of FIG. 13.

As a result SODPs in Row 2 of a view 1460 and 1470 are displayed dynamically depending on the selection of data in the SODPs in Row 1 1450 of a view.

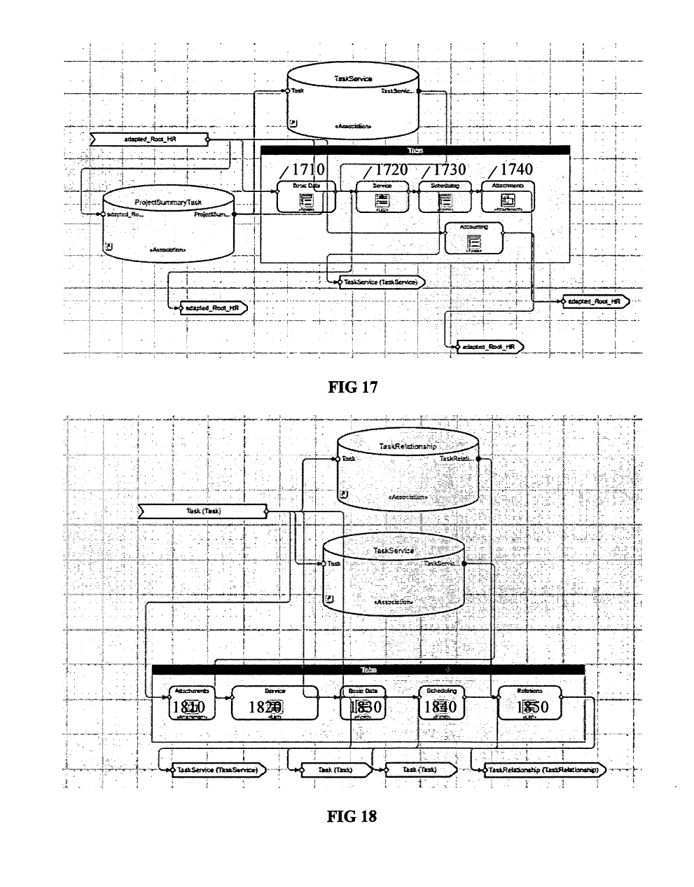

FIG. 19 demonstrates the screen where the tab ‘PST’ 2010 is selected, according to an embodiment of the invention where data from SODP 2 1460 is displayed.

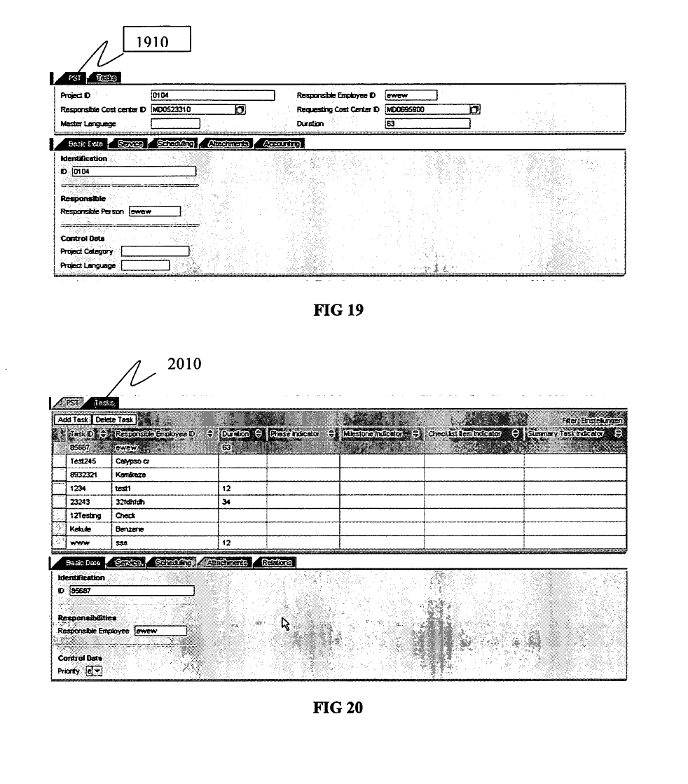

FIG. 20 demonstrates the screen where the tab ‘Task’ 2010 is selected, according to an embodiment of the invention where data from SODP 3 1470 is displayed.

The above description, with reference to the figures, shows that in a single view, it is possible to show different SODPs in the bottom row depending on the selection made on the tabs of a SODP displayed in the top row of the view.

Elements of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

What is claimed is:

1. A method comprising:
providing a plurality of object data patterns (ODPs) to display in a first portion of the view;
providing an ODP to display in a second portion of a view, the ODP including a plurality of icons from which to select one of the ODPs to display in the first portion of the view;
providing a separate connection between the ODP to display in the second portion of the view and each of the ODPs to display in the first portion of the view, each connection associated with a separate one of the icons;
providing for selection of one of the icons; and
providing for display of one of the ODPs in the first portion of the view responsive to selection of one of the icons from the second portion of the view, the selected icon associated with the connected ODP.

2. The method of claim 1, further comprising:
displaying the ODP is a second portion of the view;
receiving user input selecting one of the icons; and
displaying one of the ODPs in the first portion of the view in response to selection of one of the icons, the selected icon associated with the connection between the ODP in the second portion of the view and the one ODP in the first portion of the view.

3. The method of claim 1, wherein the number of ODPs in the first portion of the view correspond to the number of icons in the second portion of the view.

4. The method of claim 1, wherein each of the ODPs in any portion of the views is a simple object data pattern (SODP).

5. The method of claim 1, further comprising modeling the ODPs in any portion of the views, using a graphical output rendering application.

6. The method of claim 5 wherein modeling the ODP comprises modeling the ODP using SAP Netweaver Visual Composer.

7. The method of claim 1, further comprising the ODP arranging data in a list or a form, the arranged data capable of being displayed in the icons.

8. The method of claim 1, wherein the icons represent one of a Project Scheduling Task and Other Task.

9. The method of claim 1, wherein the ODP comprises data, the data having association as defined in a data model.

10. The method of claim 9, further comprising displaying the ODP as per the association defined in the data model.

11. The method of claim 1, wherein the icons represent connections to different, heterogeneous ODPs.

12. An article of manufacture, comprising:
a machine readable medium having instructions for causing the machine to execute a method comprising:
providing a plurality of object data patterns (ODPS) to display in a first portion of the view;
providing an ODP to display in a second portion of a view, the ODP including a plurality of icons from which to select one of the ODPs to display in the first portion of the view;
providing a separate connection between the ODP to display in the second portion of the view and each of the ODPs to display in the first portion of the view, each connection associated with a separate one of the icons;
providing for selection of one of the icons; and
providing for display of one of the ODPs in the first portion of the view responsive to selection of one of the icons from the second portion of the view, the selected icon associated with the connected ODP.

13. The machine-accessible medium of claim 12, further providing
displaying the ODP is a second portion of the view;
receiving user input selecting one of the icons; and
displaying one of the ODPs in the first portion of the view in response to selection of one of the icons, the selected icon associated with the connection between the ODP in the second portion of the view and the one ODP in the first portion of the view.

14. The machine-accessible medium of claim 12, wherein the number of ODPs in the first portion of the view correspond to the number of icons in the second portion of the view.

15. The machine-accessible medium of claim 12, further providing instructions which when executed by the machine, will cause the machine to perform further operations comprising:
selecting of object data pattern in the first portion of the view dynamically changes the corresponding object data pattern in the first portion of the view.

16. The machine-accessible medium of claim 12, further providing instructions which when executed by the machine, will cause the machine to perform further operations comprising:
modeling the ODPs of any portion of the views, using a graphical output rendering application.

17. The machine-accessible medium of claim 12, further providing instructions which when executed by the machine, will cause the machine to perform further operations comprising:
arranging data in a list or a form, the arranged data is capable of being displayed in the icons.

18. The machine-accessible medium of claim 12, wherein the icons are selected from a group of Project Scheduling Task and Other Task.

19. A system, comprising:
means for providing a plurality of object data patterns (ODP) in a first portion of the view;
means for providing an ODP to display in a second portion of the view, the ODP including a plurality of icons from which to select one of the ODPs to display in the first portion of the view;
means for providing a separate connection between the ODP to display in the second portion of the view and each of the ODPs to display in the first portion of the view, each connection associated with a separate one of the icons;
means for providing for selection of one of the icons; and
means for providing for display of one of the ODPs in the first portion of the view responsive to selection of one of the icons from the second portion of the view, the selected icon associated with the connected ODP.

20. The system of claim 19, further comprising:
means for displaying the ODP is a second portion of the view;
means for receiving user input selecting one of the icons; and
means for displaying one of the ODPs in the first portion of the view in response to selection of one of the icons, the selected icon associated with the connection between the ODP in the second portion of the view and the one ODP in the first portion of the view.

21. The system of claim 19, wherein the means for providing ODP in a view further has number of ODPs in the first portion of the view correspond to the number of icons in the second portion of the view.

22. The system of claim 19, wherein the means to select an object data pattern in the second portion of the view dynamically changes the corresponding object data pattern in the first portion of the view.

23. The system of claim 19, further comprising:
means for modeling the ODPs in any portion of the views, using a graphical output rendering application.

24. The system of claim 19, further comprising:
means for arranging the ODP data in a list or a form, the arranged data capable of being displayed in the icons.

25. The system of claim 19, wherein
the ODP comprises data, the data having an association as defined in a data model.

26. The system of claim 25, further comprising displaying the ODP as per the association defined in the data model.

27. The system of claim 19, wherein the icons represent connections to different, heterogeneous ODPs.
